(19) United States
(12) Patent Application Publication
(10) Pub. No.: US 2006/0104711 A1
(43) Pub. Date: May 18, 2006

(54) Method for connecting two components and a component system for carrying out the method

(76) Inventor: Willi Muller, D-Konigheim-Pulfingen (DE)

Correspondence Address: BERENATO, WHITE & STAVISH, LLC, 6550 ROCK SPRING DRIVE, SUITE 240, BETHESDA, MD, 20817, US

(21) Appl. No.: 11/211,725

(22) Filed: Aug. 26, 2005

(30) Foreign Application Priority Data
Aug. 26, 2004 (EP) 04 020 289.7

(51) Int. Cl. F16D 1/00

(52) U.S. Cl. 403/337

(57) ABSTRACT

This invention relates to a method for producing a detachable connection between two components. The first component is elastically deformed such that a clamping surface of the deformed component corresponds to a corresponding clamping surface of the other component with predetermined play. The two components can be slotted together. After the two components have been slotted together, a pressure connection is created when the deformed component elastically reforms. The first component is elastically deformed when axial forces are exerted upon force transmission sections of the component. The axial force is converted into the desired radial deformation or movement of the clamping surface by means of joints which are provided between the force transmission sections and the clamping surface.

### CROSS-REFERENCE TO RELATED APPLICATIONS AND CLAIM TO PRIORITY

This application is based upon application no. 04 020 289.7, filed August 26, 2004 with the European Patent Office, the disclosure of which is incorporated herein by reference.

### FIELD OF THE INVENTION

This invention relates to a method for creating a releasable connection between two components, wherein the first component is elastically deformed such that a clamping surface of the deformed component corresponds to a corresponding clamping surface of the other component with predetermined play, and the two components can be inserted into one another, and wherein a pressure connection is created after the two components have been inserted into one another when the deformed component is elastically reformed. Furthermore, the invention relates to a component system for carrying out the method.

### BACKGROUND OF THE INVENTION

Methods for creating a friction locking connection between two components of this type are known, for example from DE 195 21 755 C1 and DE 196 24 048 A1. With these methods, in a corresponding way, a polygonal or oval component is inserted elastically into a round shape by applying radial pressure forces so that a round shaft can be fitted while maintaining the radial pressure forces. If the radial forces are then reduced or lifted, the deformed component springs back into its oval or polygonal initial shape so that the shaft is fixed therein by means of a pressure fit.

This type of connection between two components has proven to be of value in practice. However, it is partially considered disadvantageous that the complexity of the apparatus required to apply the radial pressure forces is relatively high and it requires a lot of space.

Against this background, this invention is based upon the aim of creating a method and a component system of the type specified at the start which make it possible to apply the forces required for deformation with low apparative complexity and with a small overall size.

### SUMMARY OF THE INVENTION

This aim is fulfilled according to the invention in that the first component is elastically deformed when axial forces, and in particular tractive forces, are exerted upon force transmission sections of the component, whereupon the axial forces are converted into the desired radial deformation or movement of the clamping surface by means of joints which are provided between the force transmission sections and the clamping surface. The invention is thus based upon the idea of deforming the first component in the desired manner by applying axial forces, instead of applying radial pressure forces as in the prior art. These axial forces are then converted into the desired deformations of the clamping region by the joints which are provided between the force transmission sections and the clamping surface and for example can be in the form of solid body joints or also of pivot joints or hinges. It has been shown that this design makes it possible to produce comparably large clamping paths. By means of the large clamping paths a comparably large amount of joint play occurs between the components to be connected which can be around 0.3% of the clamping diameter, and makes possible automatic joining of the components to be connected. It is also advantageous that the deformations substantially occur in the region of the (solid body) joints whereas the clamping surface itself remains level as far as possible, by means of which optimal alignment is achieved. This is particularly applicable if the first component is formed like a sleeve in its clamping region and is provided with axial slits which guarantee that the clamping sleeve is easily deformed around its circumference.

Basically, it is possible to convert both axial pressure forces and axial tractive forces into radial deformations. According to the invention however, it is preferable to use tractive forces in order to achieve the desired deformations.

In order to convert axial tractive forces particularly effectively into radial deformations of the clamping region, the clamping surfaces of the clamping region on the one hand and the points of application of the tractive forces should be spaced apart from one another radially. If for example the first component is in the form of a mandrel with a clamping surface on the outside, the force transmission sections should lie radially within the clamping surface, and if the first component is in the form of a chuck with a retainer for a component to be clamped, the force transmission regions lie radially outside of this retainer.

If the first component is in the form of a mandrel with a clamping surface on the outside, according to one embodiment of the component system according to the invention, it is proposed that the clamping means for applying the axial tractive forces are provided in a through boring of the first component.

A constructive design of this embodiment can for example consist of one end of the first component being closed, and the clamping means being provided in order to exert a pressure force on the closed end, and so to transmit axial tractive forces into the first component.

According to a concrete embodiment, a nut is adjustably screwed into the through boring at its axial end lying opposite the closed end, pressure transfer means being provided between the closed end and the nut, so as to exert a pressure force onto the closed end when the nut is screwed in the direction of the closed end, and so transmit a tractive force into the first component. With this embodiment, just one rotation of the nut is sufficient in order to deform the clamping region of the mandrel so as to attach or detach a component.

Alternatively, it is possible to provide a hydraulically or pneumatically operated piston on the end of the first component lying opposite the closed end, pressure transfer means also being provided here between the closed end and the piston, in order to exert pressure force on the closed end by operating the piston, and thus transmit a tractive force into the first component. The piston here can be movably disposed directly in the open end of the first component.

The pressure transfer means can be formed simply by a pressure transfer rod. In order to reduce tensions or friction forces, the pressure transfer means advantageously have balls at least in the contact regions with the nut or the piston on one side and the closed end of the first component on the other side.

According to another embodiment, the component system according to this invention is designed such that a spindle is disposed in the through boring of the first component, which spindle, at its one end region, is mounted rotatably and so that it is axially movable in the first component, and at its other end region passes through a spindle nut which is mounted rotatably but so as to be axially secure in the first component, and can be driven rotatably, stops which come into contact with one another being provided on the spindle and the first component when the spindle is moved in an axial direction. With this embodiment, a rotation of the spindle nut is converted into an axial movement of the spindle which comes into contact with the stop of the first component and so exerts a pressure force thereupon. With this embodiment the through boring of the first component can also be closed so as to form a stop with which the drive spindle comes into contact.

Finally and alternatively, a rotatably driveable thread shaft can be disposed, axially securely, in the through boring of the first component, the first component being fixed on a first side of the clamping region, and a spindle nut being held in the first component on the opposite side of the clamping region, said spindle nut being engaged with a threaded section of the spindle shaft so that a rotation of the spindle shaft is converted into an axial movement of the spindle nut and of the component section connected in this, by means of which tractive forces are transmitted into the first component if this is held on the opposite first side of the clamping surface.

If the first component is in the form of a chuck with a retainer for the component to be clamped, according to a preferred embodiment of the invention it is proposed that the chuck has power transmission flanges on both axial sides of the clamping region and that a clamping device is disposed between the force transmission flanges in order to transmit tractive forces into the first component by means of the force transmission flanges. The clamping device here can be in the form of a piezo element or electrically driven positioning element which lies against the power transmission flanges and expands when current is introduced. Alternatively, the clamping device can have two eccentric rings which are rotatable in relation to one another, which lie against the force transmission flanges and are designed in such a way that their axial expansion changes if they are rotated in relation to one another. Finally, it is also possible to design the clamping device as a threaded ring which is screwed onto the one force transmission flange and comes into contact with the other force transmission flange with a front side. These last two embodiments offer the advantage that deformation of the clamping region can be brought about by manual rotation of the eccentric rings or the threaded ring.

According to an alternative application of the concept according to the invention, it is also conversely possible to convert radial forces into axial length changes. For example, by means of corresponding joints and solid body joints it is possible for radial pressure forces to be converted into axial expansions of a component. An example of an application for this according to the invention is a clamping force tester for checking the clamping force or the clamping path with hydraulic expansion chucks with a substantially cylindrical housing, a testing bolt held so as to be axially movable within the housing, said bolt being acted upon by an elastic means in the direction of the one housing end, and a display which shows a relative movement between the housing and the testing bolt. With this example of an application, the cylindrical housing is inserted into the central tool retainer of a tool holder to be tested, and then a pressure is produced by the clamping system of the tool holder in the region of the clamping surface, said pressure being converted by means of the solid body joints provided into a length change of the housing AL. This change in length is dependent upon pressure and approximately linear to the position and size of the pressure applied. The actually effective clamping force, the clamping path and the torque to be expected can be deduced from this measurement value.

With regard to additional advantageous embodiments of the invention, one should refer to the sub-claims and to the following description of examples of embodiments with reference to the attached drawings.

### BRIEF DESCRIPTION OF THE DRAWINGS

In the drawings:

FIG. 1 shows a first embodiment of a mandrel according to this invention shown in perspective,

FIG. 2 shows the mandrel from FIG. 1 in a longitudinal section,

FIG. 3 shows the mandrel from FIG. 1 in an enlarged cross-section,

FIG. 4 shows a schematic representation of a connection region between the clamping region and force transmission sections of the mandrel from FIG. 1,

FIG. 5 shows a second embodiment of a mandrel according to the invention with a piston in a longitudinal section,

FIG. 6 shows a third embodiment of a mandrel according to this invention in a longitudinal section,

FIG. 7 shows a fourth embodiment of a mandrel according to this invention in a longitudinal section,

FIG. 8 shows a first embodiment of a chuck according to this invention in a longitudinal and a cross-section,

FIG. 9 shows a second embodiment of a chuck according to this invention in a longitudinal and a cross-section,

FIG. 10 shows a third embodiment of a chuck according to this invention in a longitudinal and a cross-section,

FIG. 11 shows an embodiment of a clamping force tester according to this invention in a longitudinal section.

### DETAILED DESCRIPTION OF THE PREFERRED EMBODIMENT(S)

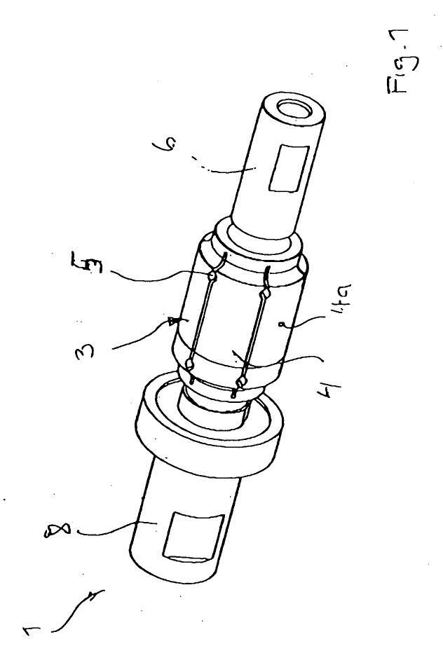

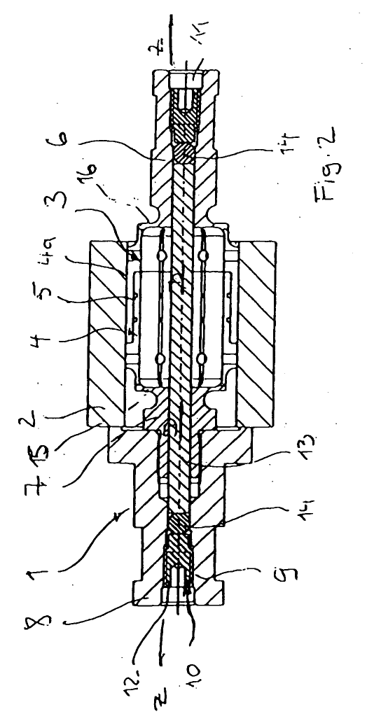

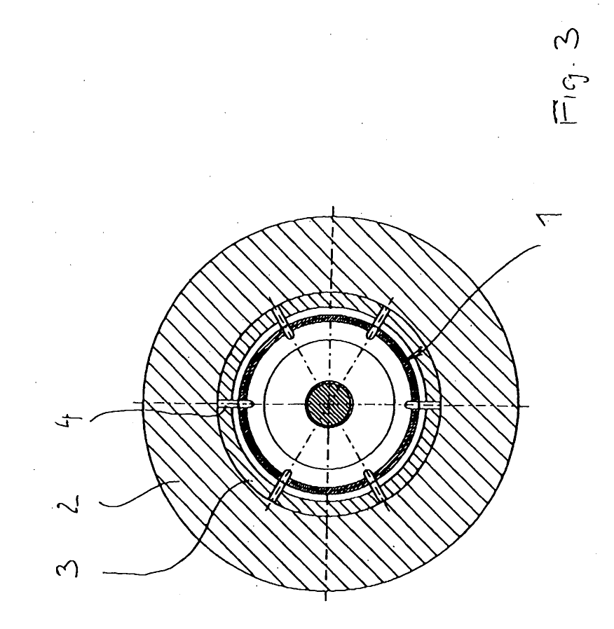

FIGS. 1 to 3 show a first component system according to this invention with a first component 1 in the form of a mandrel and an annular second component 2 which can be detachably connected to the mandrel 1 in the way shown in FIG. 2. In addition, a base section 3 of the mandrel 1 with a central, thin-walled sleeve 4 which forms an outer clamping surface 4a is provided which is elastically deformable and has a total of six axial slits 5 which are evenly spaced out around the circumference of the clamping sleeve 4. The slits 5 serve to make the clamping sleeve 4 elastic around its circumference. Axial end sections 6, 7 are attached on both sides to the central clamping sleeve 4 which have thick walls in comparison to the clamping sleeve 4.

As can be seen clearly in FIG. 2, a stop element 8 is screwed onto the left end section 7 of the base section 3 for the axial positioning of the annular element 2 on the clamping sleeve 4.

With this component system 1, 2, the annular component 2 is attached to the clamping sleeve 4 of the mandrel 1 by means of a pressure fit 4. This is created when the clamping sleeve 4, the outer diameter of which in untensioned state is a little greater than the inner diameter of the annular component 2 to be clamped, is elastically deformed inwards so that the annular component 2 can be pushed onto the clamping sleeve 4, and subsequently a pressure connection is created between the two components when the clamping sleeve 4 is elastically reformed.

According to this invention it is proposed that this deformation of the clamping sleeve 4 is brought about by means of axial tractive forces which are introduced via the end sections 6, 7 into the base section 3 of the mandrel 1. In order to produce these tractive forces 7, a clamping device 10 is provided in an axial, central through boring 9 of the mandrel 1. Two nuts 11, 12 belong to this clamping device 10, which are screwed into the axial end regions of the through boring 9 and close the same, and pressure transfer means 13, 14, which are disposed between the nuts 11, 12 in the through boring 9 so as to allow a transfer of pressure forces between the nuts 10, 11. In the example of an embodiment shown, the pressure transfer means 13, 14 comprise a central pressure transfer rod 13 which passes through the clamping sleeve 4, a steel ball 14 being provided respectively between the axial ends of the pressure transfer rod 13 and the nuts 11, 12 so as to keep any friction forces occurring as small as possible.

If one of the nuts 11, 12 is screwed into the mandrel 1 in the direction of the other nut 12, 11, this leads to compressive stresses D occurring in the clamping device 10 and as a reaction, tensile stresses Z occurring in the base section 3 and the stop element 8 fastened securely to the same.

In order to convert these tensile stresses Z into the desired, inwardly directed deformation of the clamping sleeve 4, on the one hand it is proposed that the transmission of the tractive forces from the clamping device 10 into the mandrel 1 happens radially within the clamping sleeve 4. Moreover, the thick-walled end regions 6, 7 of the base section 3 are connected to the clamping sleeve 4 by means of thin-walled solid body joints 15, 16 of the clamping sleeve 4 which on their radial outer ends are subjected to a torque which corresponds to the radially inwards working tractive forces and by means of which the upper ends of the joints 15, 16 and so also the clamping sleeve 14 are moved inwards, as shown by the arrow M in FIG. 2. The slits 5 therefore offer the space required for the contraction of the clamping sleeve 4 which occurs.

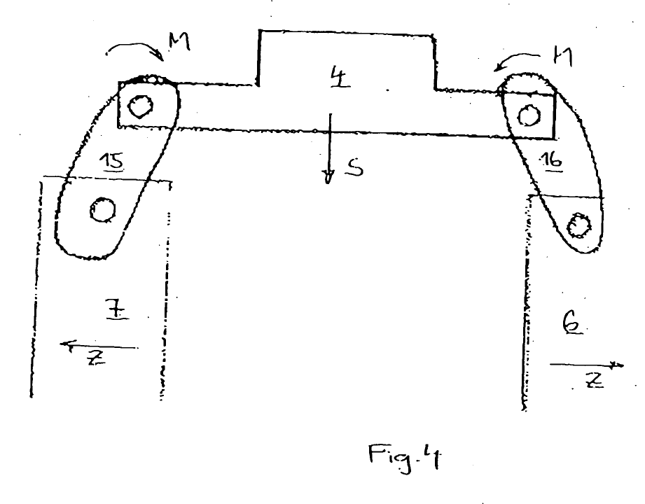

The result which is achieved here by the solid body joints 15, 16 is similar to that of pivot joints 15, 16, as shown schematically in FIG. 4. If, with this embodiment, opposing tractive forces Z are exerted upon the end sections 6, 7 of the base section 3, and the axial end sections are pulled apart, this leads to a pivotal movement of the joint lever 15, 16 which is shown by the arrow M, with the result that the clamping sleeve 4 is moved inwards, as shown by the arrow S.

Basically it is also conversely possible to exert axial pressure forces on the end sections 6, 7 of the base section 3 so that the axial end sections 6, 7 are pressed together, and this leads to a pivotal movement of the joint lever 15, 16 in the opposite direction to arrow M, with the result that the clamping sleeve 4 is moved outwards.

In other words, with the mandrel 1 shown in FIGS. 1 to 3, the clamping sleeve 4 is moved inwards so as to attach or detach the second component 2, when one of the nuts 10, 11 rotates into the mandrel 1, and in this way tractive forces are produced in the mandrel 1. The rotation rate which can be achieved here by means of the solid body joints 15, 16, is relatively high so that high levels of joint play can be established. Furthermore it is advantageous that deformations substantially only occur in the region of the solid body joints 15, 16 whereas the clamping sleeve 4, and in particular the clamping surface 4a of the same remains as even as possible, by means of which optimal axial alignment is achieved. Finally, when the clamping sleeve 4 reforms, the clamped component 2 is pulled against the stop element 8 so that optimal axial alignment can be guaranteed.

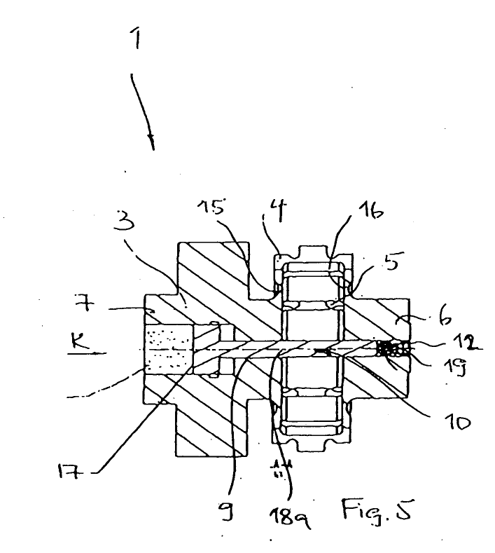

In FIG. 5, a second embodiment of a mandrel 1 according to the invention is shown. The latter corresponds in its basic structure to the mandrel 1 described above and illustrated in FIGS. 1 to 3, and has a base section 3 which is formed by a central clamping sleeve 4 and thick-walled end sections 6, 7 attached to this on the side, the axial end sections 6, 7 being connected to the clamping sleeve 4 by means of solid body joints 15, 16. Here too, the clamping device 10 is accommodated in a through boring 9 of the mandrel 1, and comprises a piston 17, which is adjustably disposed in the left axial end region of the base section 3, and can be acted upon by a hydraulic means or pneumatically. The other axial end of the through boring 9 is closed by a nut 12. With this embodiment, the piston 17 is acted upon by hydraulic means so as to press it into the base section 3 in the direction of the arrow K, the pressure force being transferred to the nut 12 by pressure transfer means 18 in the form of a piston rod 18a and a ball 18b. This pressure force once again produces tractive forces in the base section 3, even as a reaction, which are converted into an inwardly directed movement of the clamping sleeve 4 by the solid body joints 15, 16.

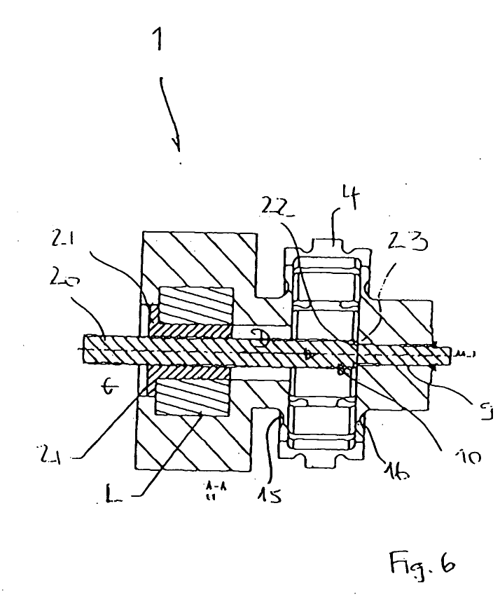

A third embodiment of a mandrel 1 according to the invention is shown in FIG. 6. In this embodiment, the tractive forces are produced by a spindle drive 10 which is disposed in the through boring 9 of the base section 3. A spindle 20 definitely belongs to the spindle drive 10, which spindle is mounted so as to be rotatably secure and axially movable in the base section 3 on its one end region (on the right in the drawing), and at its other end section on the opposite side of the clamping sleeve 4, passes through a spindle nut 21, which is mounted rotatably but so as to be axially secure in the base section 3, and rotatably driveable, in order to move the spindle 20 axially. On the spindle 20 a shoulder 22 is provided which comes into contact with a corresponding stop surface 23 of the base section 3 when the spindle 20 moves to the right from the position shown in FIG. 6 and presses against the base section 3 so that tensile stresses occur in the same which are converted by the solid body joints 15, 16 into an inwardly directed movement of the clamping sleeve 4.

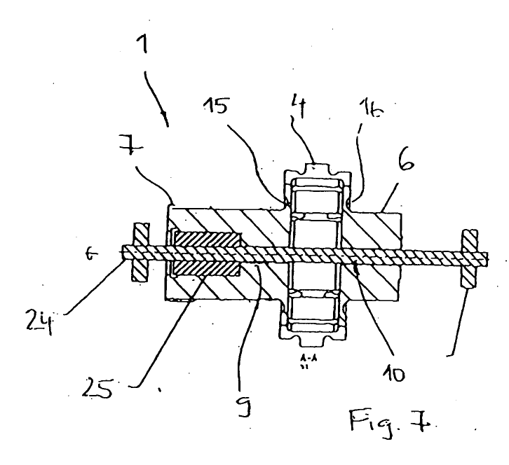

An alternative fourth embodiment is shown in FIG. 7. Also with this embodiment, the mandrel I has a base section 3 with a central clamping sleeve 4 and axial end sections 6, 7 attached to the same on both sides which are connected to the clamping sleeve 4 by solid body joints 15, 16. The clamping device 10 for applying axial tractive forces is provided in a through boring 9 of the base section. To this belongs a rotatably driveable thread shaft 24 which is disposed in the through boring 9 such as to be rotatably driveable, but axially secure, and passes through a spindle nut 25 and engages with this, which is inserted into the left end section 7 of the base section 3 and is securely connected to this, for example, pressed. With this embodiment, in order to attach a component, the right end section 6 of the base section 3 is fixed and then the thread shaft 24 is rotated so that the spindle nut 25 and so also the left end section 7 of the base section 3 is pulled to the left. The tractive forces transmitted into the base section 3 in this way are converted into the desired movement of the clamping sleeve 4 by the solid body joints 15, 16.

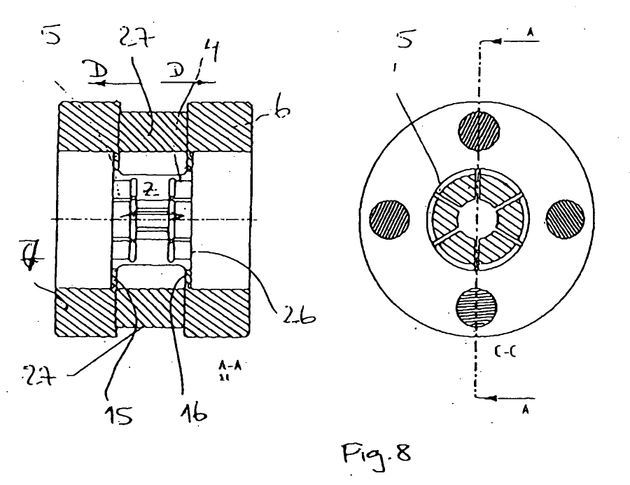

In FIGS. 8 to 10 embodiments are shown with which the first component 1 of the component system according to the invention is in the form of a chuck with a central retainer 26 for a component to be clamped (not shown in detail). The retainer 26 is provided here in a clamping sleeve 4 which, divided up circumferentially has six axial slits 5 so as to allow extensions and contractions for the clamping sleeve 4. The clamping sleeve 4 is connected to flange-like outwardly protruding end sections 6, 7 of the base section 3 by means of solid body joints 15. Between these flange-type end sections 6, 7, and radially outside of the clamping sleeve 4, a clamping device 27 is provided which offers the possibility of exerting pressure forces on the end sections 6, 7 in the direction of the arrow D so that tensile stresses Z occur in the base section 3 which are converted into downward movements of the clamping sleeve 4 by means of the solid body joints 15, 16, in the way already described, said clamping sleeve in this case being expanded so that a component 2 to be clamped can be inserted in the retainer 26.

With the example of an embodiment shown in FIG. 8, the clamping device 27 is in the form of a piezo element which is supported between the end sections 6, 7 of the base section 3 and expands when subjected to current so as to exert the desired pressure forces on the end sections 6, 7.

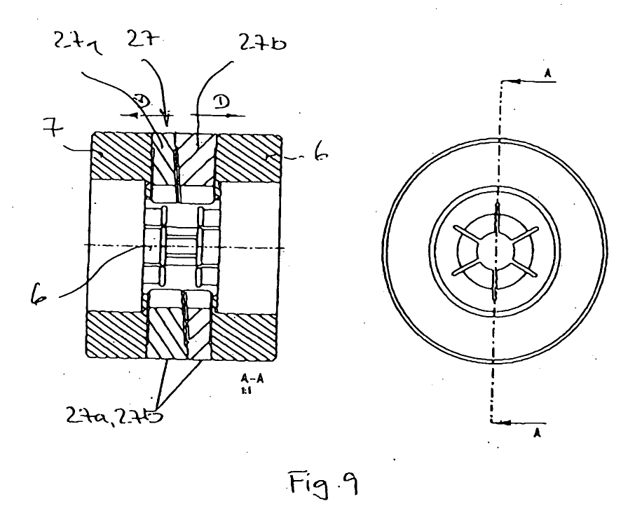

Alternatively, FIG. 9 shows an embodiment with which the clamping device 27 is formed by two eccentric rings 27a, 27b which surround the clamping sleeve 4 and are supported between the end sections 6, 7 of the base section 3. Here the pressure forces are produced when the eccentric rings 27a, 27b are rotated in relation to one another in such a way that the axial expansion of the eccentric arrangement is increased.

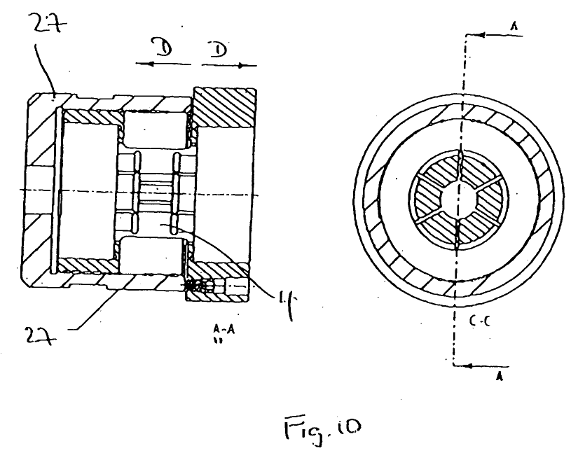

With the embodiment shown in FIG. 10, the clamping device 27 is finally in the form of a threaded ring which is screwed onto the left end section 7 of the base section 3 and on the front side lies against the right end section 6 of the base section 3.

If with this embodiment the threaded ring 27 is further screwed onto the left end section 7, it presses against the right end section 6, by means of which the desired tractive force Z is produced in the base section 3.

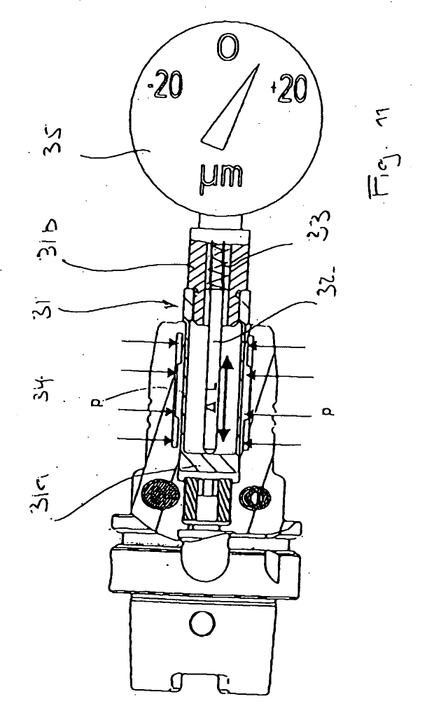

In FIG. 11 a clamping force tester 30 is shown which serves to test the clamping force or the clamping path of a hydraulic expansion chuck of conventional design. This clamping force tester 30 has a substantially cylindrical housing 31 which is formed from a bush 31a, which can be inserted into the tool retainer of the tool holder, and a cover 31b screwed securely onto the same and which carries a display 35. In the cover 31b a test piston 32 is guided axially movably which is pressed against the floor of the bush 31a by a pressure spring 33 which is supported between the test piston 32 and the cover 31a. The bush 31a forms a clamping surface 34 which projects radially slightly outwards, in the region of which the bush has thin walls and which is connected to the regions of the bush 31a which are axially joined to the clamping surface 34 by solid body joints (not shown in detail).

If, as is shown in FIG. 11, pressure forces P are produced by the tool holder and act upon the clamping surface 34 of the clamping force tester 30, there results from this a change in length of the bush 31a by ÄL because the bush 31a is elastically deformed in the region of the solid body joint. This change in length is dependent upon pressure and approximately linear to the position and size of the pressure applied.

Thus, from the measured length-change which is indicated on the display (35), the actually effective clamping force can be deduced, and thus, also the clamping path and the torque to be expected.

I claim:

1. A method for creating a releasable connection between two components (1, 2) wherein the first component (1) is elastically deformed such that a clamping surface (4a) of the deformed component (1) corresponds to a corresponding clamping surface of the other component (2) with predetermined play, and the two components (1, 2) can be inserted into one another, and wherein, after the two components (1, 2) have been inserted into one another, a pressure connection is created when the deformed component (1) is elastically reformed, characterised in that the first component (1) is elastically deformed when axial forces are exerted upon force transmission sections (6, 8) of the component (1), the axial forces being converted by joints (15, 16), which are provided between the power transmission sections (6, 8) and the clamping surface (4a), into the desired radial deformation or movement of the clamping surface (4a).

2. The method according to claim 1, characterised in that the forces are converted into radial deformations or movements of the clamping surface (4a) by solid body joints (15, 16).

3. The method according to claim 1, characterised in that the forces are converted into radial deformations or movements of the clamping surface (4a) by pivot joints (15, 16).

4. The method according to claim 1, characterised in that the first component (1) is in the form of a mandrel with an externally lying clamping surface (4a) wherein axial tractive forces are transmitted into the component (1) in a region lying radially within the clamping surface (4a).

5. The method according to claim 1, characterised in that the first component (1) is in the form of a chuck with a retainer for the component (2) to be clamped, axial tractive forces being transmitted into the component (2) in a region lying radially outside of the retainer.

6. A component system with two components (1, 2) to be connected, wherein the first component (1) is elastically deformable such that a clamping surface (4a) of the deformed component (1) corresponds to a corresponding clamping surface of the other component (2) with predetermined play, and the two components (1, 2) can be inserted into one another, and wherein, after the two components (1, 2) have been inserted into one another, a pressure connection can be created, by elastically reforming the deformed component (1), characterised in that the first component (1) has force transmission sections (6, 8), in particular in the region of its axial ends, by means of which axial forces can be exerted upon the component (1), wherein between the force transmission sections (6, 8) and the clamping surface (4a) joints (15, 16) are disposed such that the axial forces are converted into a desired radial deformation or movement of the clamping surface (4a).

7. The component system according to claim 6, characterised in that the joints are in the form of solid body joints (15, 16).

8. The component system according to claim 6, characterised in that the joints are in the form of pivot joints (15, 16).

9. The component system according to claim 6, characterised in that the first component (1) is in the form of a thin-walled clamping sleeve (4) in the region of its clamping surface (4a).

10. The component system according to claim 6, characterised in that the first component (1) is provided with axial slits (5) in the region of the clamping surface (4a) for increasing the deformability, in particular circumferentially.

11. The component system according to claim 6, characterised in that the first component (1) is in the form of a mandrel with a clamping surface (4a) lying to the outside, and the force transmission sections (6, 8) for transmitting tractive forces lie radially within the clamping surface (4a).

12. The component system according to claim 11, characterised in that the first component (1) has a through boring (9) and clamping means (10) are provided in the through boring so as to exert axial tractive forces upon the first component (1).

13. The component system according to claim 12, characterised in that the through boring (9) is closed on its one end region.

14. The component system according to claim 13, characterised in that in the through boring (9) on its axial end opposite the closed end of the first component (1), a nut (11) is adjustably screwed, pressure transfer means (13, 14) being provided between the closed end and the nut (11) so as to exert a pressure force upon the closed end when the nut (11) is screwed in the direction of the closed end, and so to transmit a tractive force into the first component (1).

15. The component system according to claim 13, characterised in that on the end of the first component (1) lying opposite the closed end, a hydraulically or pneumatically operatable piston (17) is provided, pressure transfer means (18) being provided between the closed end and the piston (17) so as to exert a pressure force upon the closed end by means of the pressure transfer means when the piston is operated (17), and so to transmit a tractive force into the first component (1).

16. The component system according to claim 15, characterised in that the piston (17) is disposed movably in the open end of the first component (1).

17. The component system according to claim 14, characterised in that the pressure transfer means have a pressure transfer rod (13, 18a).

18. The component system according to claim 14, characterised in that the pressure transfer means have balls (14, 18b), particularly in the region of the region coming into contact with the closed end of the first component (1).

19. The component system according to claim 13, characterised in that in the through boring (9) of the first component (1) a spindle (20) is disposed which is mounted at its one end region so as to be rotatable and axially movable in the first component (1), and at its other end region passes through a spindle nut (21), which is mounted in the first component (1) so as to be rotatable, but axially secure, and is rotatably driveable, stops (22, 23) being provided on the spindle (18) and the first component (1) which come into contact with one another when the spindle (20) is moved in an axial direction.

20. The component system according to claim 13, characterised in that in the through boring (9) of the first component (1) a rotatably drivable thread shaft (24) is disposed so as to be axially secure, wherein the first component is fixed onto one side of the clamping surface (4a) and on the opposite side of the clamping region a spindle nut (25) is held in the first component (1) which engages with a threaded section of the spindle shaft (24), so that a rotation of the spindle shaft (24) is converted into an axial movement of the spindle nut (25) by means of which tractive forces are transmitted into the first component (1).

21. The component system according to claim 6, characterised in that the first component is in the form of a chuck (1) with a retainer (26) for the component to be clamped (2), and the force transmission regions (6, 7) lie radially outside of the retainer (26).

22. The component system according to claim 21, characterised in that the chuck (1) has force transmission flanges (6, 7) on both axial sides of the clamping region, and a clamping device (27) is disposed between the force transmission flanges (6, 7) so as to transmit tractive forces into the first component (1) by means of the force transmission flanges (6, 7).

23. The component system according to claim 22, characterised in that the clamping device (27) is in the form of a piezo element which lies on the force transmission flanges (6, 7) and expands when current is introduced.

24. The component system according to claim 22, characterised in that the clamping device (27) is formed with two eccentric rings (27a, 27b) which can rotate in relation to one another, which lie on the force transmission flanges (6, 7) and are formed in such a way that the axial expansion of the eccentric ring arrangement changes when they are rotated in relation to one another.

25. The component system according to claim 22, characterised in that the clamping device (27) is in the form of a threaded ring which is screwed onto a force transmission flange (7) and comes into contact with the other force transmission flange (6) with a front side.

26. A clamping force tester for checking the clamping force or the clamping path of chucks, with a substantially cylindrical housing (31), a testing bolt (32) held in the housing (31) so as to be axially movable, which is acted upon by an elastic means (33) in the direction of the one housing end, and a display (35) which displays a relative movement between the housing (31) and the testing bolt (32), characterised in that the housing (31) has a clamping surface (34) by means of which radial pressure forces can be transmitted into the housing (31) when the housing (31) is inserted in a central retainer of a chuck to be tested, wherein the radial pressure forces are converted into axial expansions of the housing (31) by means of solid body joints which are provided in the transition regions to the regions of the housing (31) axially connected to the clamping surface (34), which are displayed on the display (35).
